(19) United States
(12) Patent Application Publication
(10) Pub. No.: US 2016/0154743 A1
(43) Pub. Date: Jun. 2, 2016

(54) FLUSHING DIRTY DATA FROM CACHE MEMORY

(71) Applicant: HEWLETT-PACKARD DEVELOPMENT COMPANY, L.P., Houston, TX (US)

(72) Inventors: Weimin Pan, Houston, TX (US); Mark J. Thompson, Houston, TX (US)

(73) Assignee: Hewlett-Packard Development Company, L.P., Houston, TX (US)

(21) Appl. No.: 14/786,474

(22) PCT Filed: Jun. 25, 2013
(86) PCT No.: PCT/US2013/047536

§ 371 Date: Oct. 22, 2015

(51) Int. Cl. G06F 12/12; G06F 12/08

(52) U.S. Cl. CPC G06F 12/12; G06F 12/0891; G06F 2212/69

(57) ABSTRACT

Disclosed herein are a system, non-transitory computer readable medium, and method to reduce input and output transactions. It is determined whether a first set of dirty data, a second set of dirty data, and a number of data blocks therebetween can be flushed with one transaction.

### FLUSHING DIRTY DATA FROM CACHE MEMORY

Cache memory may be utilized by storage controllers to reduce the number of input and output transactions to and from a storage unit. Cache memory may be arranged in accordance with logical block addressing (“LBA”) such that blocks of data therein are linearly or sequentially addressed. The blocks of data may be divided into multiple cache lines.

### BRIEF DESCRIPTION OF THE DRAWINGS

FIG. 1 I is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, linearly addressed cache memory blocks may be divided into multiple cache lines. Each cache line may have bits of metadata associated therewith that indicates whether a block of data in the cache line contains valid data (“valid bit”) or whether a block of data contains dirty data (“dirty bit”). In one example, dirty data may be defined as a block of data that has been altered since it was cached from storage such that the block of data in cache is more recent than its corresponding block in storage. A cache placement module may be used to determine which data blocks should be written to storage from cache memory to make room for new data. Such modules may search for a cache line without dirty data and may overwrite the blocks therein with the new data.

If a cache placement module is unable to locate a cache line free of dirty data, a storage controller may need to “flush” dirty data from a cache line before it can overwrite it with new data, In one example, a flush transaction may be defined as a write of dirty data back to storage from cache memory. Unfortunately, these flush transactions may hinder the overall performance of a storage unit. The performance of the storage unit may depend on how fast the controller can flush dirty data from cache memory. A heavy workload may cause a considerable increase in read/write transactions executed in storage. In turn, the deterioration in performance caused by the increase in transactions may be problematic for applications writing and reading data to and from storage.

In view of the foregoing, disclosed herein are a system, non-transitory computer readable medium, and method for reducing input and output transactions. In one example, it is determined whether a first set of dirty data blocks, a second set of dirty data blocks, and a number of data blocks therebetween can be flushed with one transaction in order to reduce overall input and output transactions to and from a storage unit. Rather than confining the flush transaction to dirty data scheduled for replacement by new cache data, the techniques disclosed herein may determine whether it's feasible to flush additional dirty data in the same transaction. Thus, the system, non-transitory computer readable medium, and method disclosed herein may enhance the performance of a storage system by further reducing the overall number of input and output transactions to and from the storage unit. The aspects, features and advantages of the present disclosure will be appreciated when considered with reference to the following description of examples and accompanying figures. The following description does not limit the application; rather, the scope of the disclosure is defined by the appended claims and equivalents.

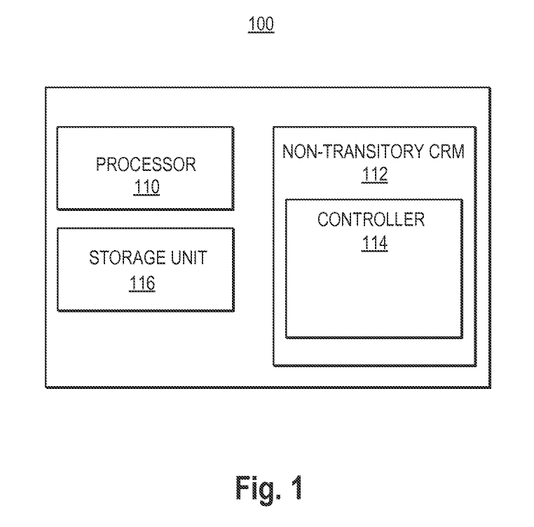

FIG. 1 presents a schematic diagram of an illustrative computer apparatus 100 for executing the techniques disclosed herein. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor. TV, projector, etc. Computer apparatus 100 may also comprise a network interface (not shown) to communicate with other devices over a network. The computer apparatus 100 may also contain a processor 110, which may be any number of well known processors, such as processors from Intel ® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include a controller 114. Non-transitory CRM 112 may be used by or in connection with any instruction execution system that can fetch or obtain the logic therefrom and execute the instructions contained therein.

Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in controller 114 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

In another example, controller 114 may be firmware executing in a controller for storage unit 116. While FIG. 1 depicts storage unit 116 housed in computer apparatus 100, it is understood that storage unit 116 may also be housed in a remote computer. In the example of FIG. 1, controller 114 may be coupled to computer 100 via a host-side interface, such as fiber channel (“FC”), internet small computer system interface (“iSCSi”), or serial attached small computer system interface (“SAS”), which allows computer 100 to transmit one or more input/output requests to storage unit 116. In one example, storage unit 116 may be a redundant array of independent disks (“RAID”). Controller 114 may communicate with storage unit 116 via a drive-side interface (e.g., FC, storage area network (“SAS”), network attached storage (“NAS”), etc.).

As noted above, a cache memory may be utilized to cache data from the storage unit. In one example, controller 114 may instruct processor 110 to read a request to write a first set of dirty data blocks back to storage unit 116 from the cache memory. This request may originate from a cache placement module. In another example, controller 114 may instruct processor 110 to determine whether the first set of dirty data blocks, a second set of dirty data blocks, and a number of data blocks therebetween can be written to storage unit 116 from cache memory with one flush transaction. This may reduce overall input and output transactions to and from storage unit 116. In a further example, in order to determine whether one transaction may be used in such a way, controller 114 may determine whether the number of data blocks between the first and second set of dirty data blocks is within a predetermined threshold. In another example, controller 114 may determine whether there is sufficient bandwidth to carry out the transaction. In yet another aspect, controller 114 may determine whether each data block between the first and second set of dirty data blocks is valid. If nor, valid data may be read from storage into any data block between the first and second set that contains invalid data. In one example, invalid data may be defined as data that has not been cached from storage.

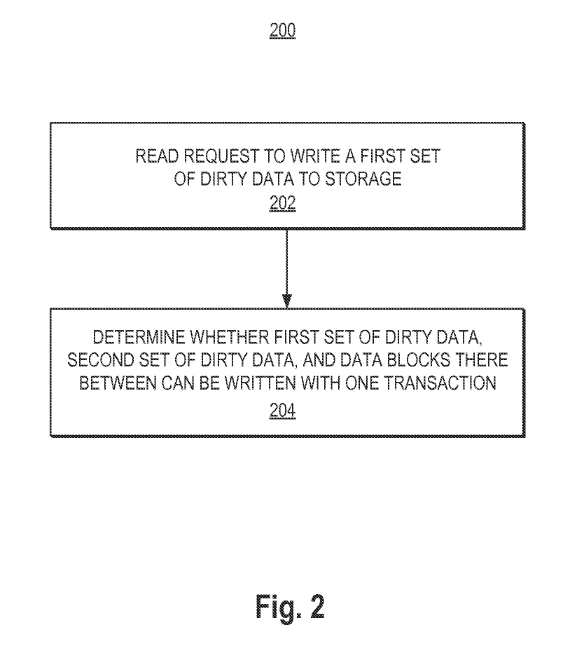

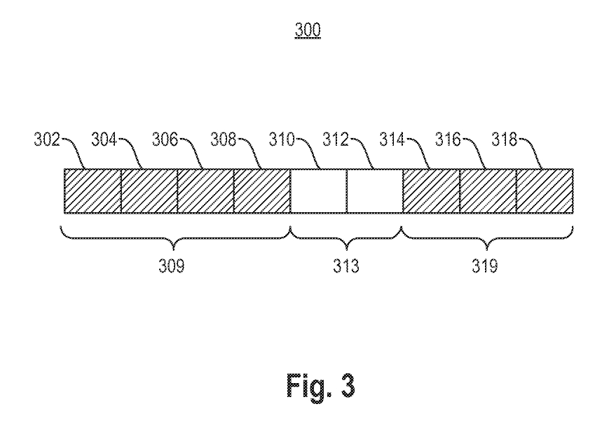

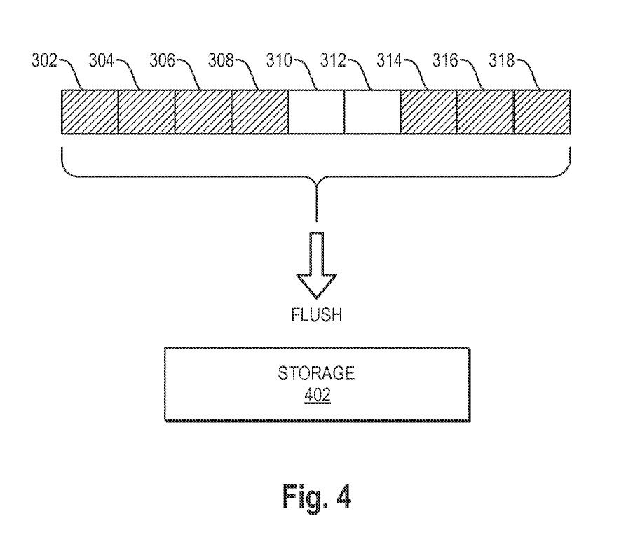

Working examples of the system, method, and non-transitory computer readable medium are shown in FIGS. 2-4. In particular, FIG. 2 illustrates a flow diagram of an example method 200 for reducing input and output transactions. FIGS. 3-4 show working examples in accordance with aspects of the present disclosure. The actions shown in FIGS, 3-4 will be discussed below with regard to the flow diagram of FIG. 2.

As shown in block 202 of FIG. 2, a request to write a first set of dirty data to storage from a cache memory may be read. Such a request may be generated by a cache placement module. Referring now to FIG. 3, a series of linearly addressed data blocks 302-318 are shown. By way of example, data blocks 302-308 belong to a first set of dirty data blocks 309. In this working example, the cache placement module requests that the first set of dirty data blocks 309 be written to storage in order In accommodate new incoming cache data. Referring back to FIG. 2, it may be determined whether a first set of dirty data, a second set of dirty data, and data blocks therebetween can be written to storage with one transaction, as shown in block 204.

Referring back to FIG. 3, data blocks 314-318 may form a second set of dirty data blocks 319. In this example, the first set of dirty data blocks 309 and the second set of dirty data blocks 319 are discontinuous and separated by blocks 310 and 312, which form intermediate data blocks 313. Intermediate data blocks 313 may contain data that is not dirty. Thus, it may be determined whether the first set of dirty data blocks 309, the second set of dirty data blocks 319, and the intermediate data blocks 313 may be written to storage in one flush transaction, in order to minimize overall input and output transactions to and from storage. As noted above, in order to determine whether one cache flush transaction can be so executed, controller 114 may determine whether the number of data blocks between the first and second set of dirty data is within a predetermined threshold. In one example, the predetermined threshold is met when the dirty data blocks of the first and second set combined outnumber the non-dirty data blocks therebetween.

Since intermediate data blocks 313 are non-dirty, the data in these intermediate blocks may already be synchronized with their corresponding blocks in storage. While including these intermediate, non-dirty data blocks in the flush transaction may be redundant, if the non-dirty data blocks are outnumbered by the dirty data blocks of the first and second set combined, the benefit of including these non-dirty blocks in the one flush transaction may outweigh the cost of having extra flush transactions in the future. Conversely, if the dirty data blocks in the first and second set combined are outnumbered by the non-dirty data blocks therebetween, the cost may outweigh the benefit.

Other factors that may be considered when determining whether to use one transaction In flush discontinuous dirty data blocks may be whether the system has enough bandwidth to execute the one transaction. In another example, it may be determined whether each data block between the two sets of dirty data blocks contains valid data. This may be determined by checking the valid bit associated with each data block. If a data block between the first and second set of dirty data blocks contains invalid data, valid data may be read into the data block. As noted above, invalid data may be defined as data that was not cached from storage. If the flush transaction were executed with such invalid data between the first and second set, the data blocks in storage corresponding to the invalid data blocks may be overwritten. Therefore, the invalid data in the blocks between the first and second set of dirty data blocks may be replaced with valid data from storage before executing the one flush transaction. In this instance, in addition to writing the first and second set of dirty data blocks, the one flush transaction also rewrites the valid data just read into the invalid data blocks right back to storage. In one example, the cost of reading valid data from storage into the invalid data blocks is outweighed by the benefits of reduced future transactions, when the number of non-dirty data blocks is within the predetermined threshold as explained above.

Referring now to FIG. 4, if it is determined that one flush transaction can be used to write blocks 302 thru 318 to storage, the flush transaction may be executed and the blocks may be written to their corresponding blocks in storage unit 402. As discussed above, while blocks 310 and 312 may already be synchronized with their corresponding blocks of data in storage (i.e., the blocks are not dirty) the benefit of including these non-dirty blocks in the flush transaction may outweigh the cost, when the number of blocks are within the threshold. The benefit is the reduction of overall input and output transactions. For example, in a RAID 5 storage unit, each flush request may require four input and output transactions (e.g., 2 read transactions and 2 write transactions). Therefore, by including additional dirty data in the flush transaction, future transactions may be reduced. While the examples herein show two sets of discontinuous dirty data blocks being flushed in one transaction with intermediate non-dirty blocks therebetween, it is understood that more than two or multiple sets of discontinuous dirty data blocks may be flushed with one transaction, if the sum of all the non-dirty data blocks between the multiple sets is less than the sum of all the dirty data blocks of the multiple sets combined. Furthermore, in the case of multiple sets of discontinuous dirty data blocks, the bandwidth considerations and valid data considerations mentioned above are also applicable. Flushing multiple sets of dirty data blocks in one transaction further minimizes future input and output transactions to and from storage.

Advantageously, the foregoing system, method, and non-transitory computer readable medium reduces overall input and output transactions to and from storage. Rather than limiting a flush transaction to dirty data that will be replaced with new data, additional dirty data may also be flushed in the same transaction. Thus, the techniques disclosed herein may cope with heavier workloads better than conventional systems. In turn, the performance of user applications may be maintained despite increased stress on the storage unit.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising;
a storage unit;
a cache memory to cache data from the storage unit;
a controller which, if executed, instructs at least one processor to:
read a request to write a first set of dirty data blocks to the storage unit from the cache memory; and
determine whether the first set of dirty data blocks, a second set of dirty data blocks, and a number of data blocks therebetween can be written to the storage unit from the cache memory with one flush transaction, in order to reduce overall input and output transactions to and from the storage unit.

2. The system of claim 1, wherein to determine whether the one flush transaction can be carried out, the controller, if executed, instructs at least one processor to determine whether the number of data blocks between the first set and second set is within a predetermined threshold.

3. The system of claim 1, wherein to determine whether the one flush transaction can be carried out, the controller, if executed, instructs at least one processor to determine whether there is sufficient bandwidth to carry out the transaction.

4. The system of claim 1, wherein to determine whether the one flush transaction can be carried out, the controller, if executed, instructs at least one processor to determine whether each data block between the first set of dirty data blocks and the second set of dirty data blocks is valid.

5. The system of claim 4, wherein if a block of data between the first set and the second set is not valid, the controller, if executed, instructs at least one processor to read valid data into the block of data.

6. A non-transitory computer readable medium having instructions therein which, if executed, cause at least one processor to:
read a request to cache data in a cache memory;
locate a first set of dirty data blocks scheduled for writing to a storage unit from the cache memory in order to accommodate the request to cache data;
determine whether one cache flush transaction can be used to write the first set of dirty data blocks, a second set of dirty data blocks, and a number of data blocks therebetween to the storage unit so as to minimize overall input and output transactions to and from the storage unit; and
execute the one cache flush transaction, if it is determined that the one cache flush transaction can be used.

7. The non-transitory computer readable medium of claim 6, wherein the instructions therein, if executed, instruct at least one processor to determine whether the number of data blocks between the first set and second set is within a predetermined threshold in order to determine whether the one cache flush transaction can be used.

8. The non-transitory computer readable medium of claim 6, wherein the instructions therein, if executed, instruct at least one processor to determine whether there is sufficient bandwidth to carry out the one cache flush transaction.

9. The non-transitory computer readable medium of claim 6, wherein the instructions therein, if executed, instruct at least one processor to determine whether each data block between the first set of dirty data blocks and the second set of dirty data blocks contains valid data in order to determine whether the one cache flush transaction can be used.

10. The non-transitory computer readable medium of claim 9, wherein the instructions therein, if executed, instruct at least one processor to read valid data into a block of data between the first set and the second set, if the block of data contains invalid data.

11. A method comprising reading, using at least one processor, a request from a cache placement module to write a first set of dirty data to a storage unit from a cache memory;
locating, using at least one processor, a second set of dirty data in the cache memory that is separated from the first set of dirty data by a number of data blocks;
determining, using at least one processor, whether the first set of dirty data, the second set of dirty data, and the number of data blocks therebetween can be written to the storage unit with one flush transaction, in order to minimize overall input and output transactions to the storage unit; and
executing, using at least one processor, the one flush transaction, if it is determined that the one flush transaction can be used.

12. The method of claim 11, wherein determining whether the one flush transaction can be used comprises determining, using at least one processor, whether the number of data blocks between the first set of dirty data and the second set of dirty data is within a predetermined threshold.

13. The method of claim 11, wherein determining whether the one flush transaction can be used comprises determining, using at least one processor, whether there is sufficient bandwidth to carry out the transaction.

14. The method of claim 11, wherein determining whether the one flush transaction can be used comprises determining, using at least one processor, whether each data block between the first set of dirty data and the second set of dirty data contains valid data.

15. The method of claim 14, further comprising reading valid data into a block of data in between the first set and the second set, if it is determined that the block of data contains invalid data.
